(19) United States
(12) Patent Application Publication
(10) Pub. No.: US 2026/0286911 A1
(43) Pub. Date: Sep. 24, 2026

(54) SYSTEM AND METHOD FOR EVALUATING PERFORMANCE OF WORK MACHINE

(71) Applicant: KOMATSU LTD., Tokyo (JP)

(72) Inventors: Yuki OZAWA, Tokyo (JP); Ryoji KASUYA, Tokyo (JP)

(21) Appl. No.: 19/478,349

(22) PCT Filed: May 23, 2024
(86) PCT No.: PCT/JP2024/019110

§ 371 Date: Oct. 24, 2025

(30) Foreign Application Priority Data
Jul. 31, 2023 (JP) 2023-124673

(51) Int. Cl. F02D 41/22; F02B 39/16

(52) U.S. Cl. CPC F02D 41/22; F02B 39/16

(57) ABSTRACT

A system evaluates performance of a work machine including an engine and a turbocharger. The system includes an actual charge pressure acquisition unit, a target torque acquisition unit that acquires a target output torque of the engine, an engine rotation speed acquisition unit, a charge pressure estimation unit that calculates an estimated charge pressure of the turbocharger based on the target output torque of the engine and the actual rotation speed of the engine, a charge pressure correction unit, and a deviation degree calculation unit. The charge pressure correction unit acquires a change amount of a predetermined correction parameter to change the target output torque of the engine as a first torque change amount, and corrects the estimated charge pressure based on the first torque change amount. The deviation degree calculation unit calculates a deviation degree between the actual charge pressure and the corrected estimated charge pressure.

### CROSS-REFERENCE TO RELATED APPLICATIONS

This application is a U.S. National stage application of International Application No. PCT/JP2024/019110, filed on May 23, 2024. This U.S. National stage application claims priority under 35 U.S.C. § 119(a) to Japanese Patent Application No. 2023-124673, filed in Japan on Jul. 31, 2023. The entire contents of Japanese Patent Application No. 2023-124673 is hereby incorporated herein by reference.

### BACKGROUND

### Technical Field

The present disclosure relates to a system and a method for evaluating the performance of a work machine.

### Background Art

There has been known a method for evaluating the performance of a turbocharger based on the deviation degree between the actual charge pressure of the turbocharger and the estimated charge pressure. For example, a failure detection device of Japanese Laid-Open Patent Publication No. 2013-184512 A calculates an estimated value of the charge pressure based on an engine rotation speed and a pump load of a hydraulic pump. The failure detection device determines a failure of the turbocharger based on a deviation between the estimated value of the charge pressure and the measured value of the charge pressure.

### SUMMARY

In the case of estimating the charge pressure as described above, the charge pressure can be estimated with high accuracy by calculating the charge pressure from data acquired in a state where the engine is stable. Therefore, the charge pressure is desirably calculated from the data acquired when a predetermined condition is satisfied. With the predetermined condition being stricter, the charge pressure can be estimated with higher accuracy.

However, in a work machine used at a work site such as a mine, the charge pressure can be calculated in the stable state under limited number of situations. Therefore, if the accuracy of the estimation of the charge pressure is improved by making the predetermined condition stricter, only a small amount of data can be used for the performance evaluation. Therefore, improvement in the accuracy of performance evaluation is not an easy task. An object of the present disclosure is to accurately calculate a deviation degree of a charge pressure in a work machine.

A system according to a first aspect of the present disclosure is a system for evaluating performance of a work machine. The work machine includes an engine and a turbocharger connected to the engine. A system according to the first aspect includes an actual charge pressure acquisition unit, a target torque acquisition unit, an engine rotation speed acquisition unit, a charge pressure estimation unit, a charge pressure correction unit, and a deviation degree calculation unit. The actual charge pressure acquisition unit acquires an actual charge pressure of the turbocharger. The target torque acquisition unit acquires a target output torque of the engine. The engine rotation speed acquisition unit acquires an actual rotation speed of the engine. The charge pressure estimation unit calculates an estimated charge pressure of the turbocharger based on the target output torque of the engine and the actual rotation speed of the engine. The charge pressure correction unit acquires a change amount of a predetermined correction parameter for changing the target output torque of the engine as a first torque change amount. The charge pressure correction unit corrects the estimated charge pressure based on the first torque change amount. The deviation degree calculation unit calculates a deviation degree between the actual charge pressure and the corrected estimated charge pressure.

A system according to a second aspect of the present disclosure is a system for evaluating performance of a work machine. The work machine includes an engine and a turbocharger connected to the engine. A system according to the second aspect includes an actual charge pressure acquisition unit, a target torque acquisition unit, an engine rotation speed acquisition unit, a charge pressure estimation unit, a charge pressure correction unit, and a deviation degree calculation unit. The actual charge pressure acquisition unit acquires an actual charge pressure of the turbocharger. The target torque acquisition unit acquires a target output torque of the engine. The engine rotation speed acquisition unit acquires an actual rotation speed of the engine. The charge pressure estimation unit calculates an estimated charge pressure of the turbocharger based on the target output torque of the engine and the actual rotation speed of the engine. The charge pressure correction unit acquires a first rotation speed change amount indicating a change amount of the actual rotation speed of the engine. The charge pressure correction unit corrects the estimated charge pressure based on the first rotation speed change amount. The deviation degree calculation unit calculates a deviation degree between the actual charge pressure and the corrected estimated charge pressure.

A method according to a third aspect of the present disclosure is a method for evaluating performance of a work machine. The work machine includes an engine and a turbocharger connected to the engine. The method according to the third aspect includes acquiring an actual charge pressure of the turbocharger, acquiring a target output torque of the engine, acquiring an actual rotation speed of the engine, calculating an estimated charge pressure of the turbocharger based on the target output torque of the engine and the actual rotation speed of the engine, acquiring a change amount of a predetermined correction parameter for changing the target output torque of the engine as a first torque change amount, correcting the estimated charge pressure based on the first torque change amount, and calculating a deviation degree between the actual charge pressure and the corrected estimated charge pressure.

A method according to a fourth aspect of the present disclosure is a method for evaluating performance of a work machine. The work machine includes an engine and a turbocharger connected to the engine. The method according to the fourth aspect includes acquiring an actual charge pressure of the turbocharger, acquiring a target output torque of the engine, acquiring an actual rotation speed of the engine, calculating an estimated charge pressure of the turbocharger based on the target output torque of the engine and the actual rotation speed of the engine, acquiring a first rotation speed change amount indicating a change amount of the actual rotation speed of the engine, correcting the estimated charge pressure based on the first rotation speed change amount, and calculating a deviation degree between the actual charge pressure and the corrected estimated charge pressure.

According to the present disclosure, it is possible to accurately calculate a deviation degree of a charge pressure in a work machine.

### BRIEF DESCRIPTION OF DRAWINGS

Referring now to the attached drawings which form a part of this original disclosure, an illustrative embodiment is shown.

FIG. 1 is a perspective view of a work machine according to an embodiment.

FIG. 2 is a block diagram illustrating a configuration of the work machine and a system for evaluating the performance of the work machine.

FIG. 3 is a table illustrating a configuration of machine data.

FIG. 4 is a block diagram illustrating a configuration of a server.

FIG. 5 is a flowchart illustrating processing of generating determination data for evaluating the performance.

FIG. 6 is a diagram illustrating an example of charge pressure estimation data.

### DETAILED DESCRIPTION OF EMBODIMENT(S)

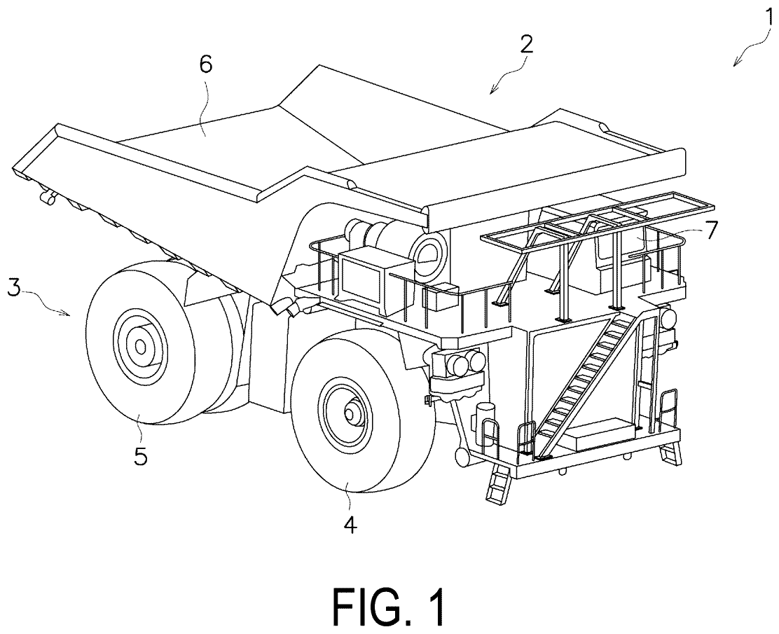

Hereinafter, an embodiment of the present disclosure will be described with reference to the accompanying drawings. FIG. 1 is a perspective view of a work machine 1 according to the embodiment. The work machine 1 according to the present embodiment is a dump truck. As illustrated in FIG. 1, the work machine 1 includes a vehicle body 2 and a traveling device 3. The vehicle body 2 includes a loading platform 6 and a cab 7. The traveling device 3 is attached to the vehicle body 2. The traveling device 3 includes traveling wheels 4 and 5.

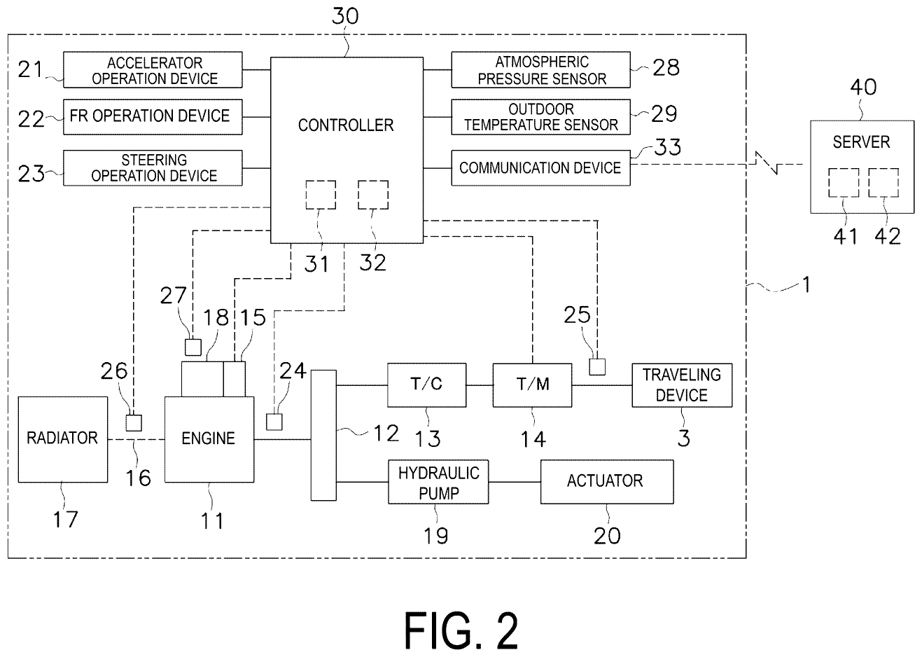

FIG. 2 is a block diagram illustrating a configuration of the work machine 1 and a system for evaluating performance of the work machine 1. As illustrated in FIG. 2, the work machine 1 includes an engine 11, a power take-off (PTO) 12, a torque converter 13, and a transmission 14. The engine 11 is, for example, a diesel engine. A fuel injection device 15 and a turbocharger 18 are connected to the engine 11. The fuel injection device 15 injects the fuel into the engine 11. The turbocharger 18 includes, for example, a turbine. The turbocharger 18 compresses intake air and supplies the compressed air to the engine 11.

A radiator 17 is connected to the engine 11 via a cooling pipe 16. The radiator 17 cools a coolant for the engine 11. The torque converter 13 is connected to the engine 11 via the PTO 12. The torque converter 13 transmits the driving force from the engine 11 to the transmission 14.

The transmission 14 is connected to the torque converter 13. The transmission 14 transmits the driving force from the torque converter 13 to the traveling device 3. Thus, the traveling device 3 is driven and the work machine 1 travels. The transmission 14 includes a plurality of shift gears, a forward gear, a reverse gear, and a clutch. The clutch switches the engagement of each gear. The transmission 14 can be switched among a plurality of speed stages through the switching of engagement of the plurality of shift gears.

The work machine 1 includes a hydraulic pump 19 and an actuator 20. The hydraulic pump 19 is connected to the engine 11 via the PTO 12. The hydraulic pump 19 discharges hydraulic oil upon being driven by the engine 11. The actuator 20 is driven by the hydraulic oil from the hydraulic pump 19. The actuator 20 includes, for example, a steering actuator for steering the traveling wheels 4. Note that, although only one hydraulic pump 19 is illustrated in FIG. 2, the work machine 1 may include a plurality of hydraulic pumps. Although only one actuator 20 is illustrated in FIG. 2, the work machine 1 may include a plurality of actuators.

The work machine 1 includes an accelerator operation device 21, an FR operation device 22, and a steering operation device 23. The accelerator operation device 21 can be operated by an operator in order to adjust the vehicle speed of the work machine 1. The accelerator operation device 21 includes, for example, an accelerator pedal. Alternatively, the accelerator operation device 21 may include a lever or a switch. The accelerator operation device 21 outputs an accelerator operation signal indicating an operation on the accelerator operation device 21.

The FR operation device 22 is operable by an operator to switch between forward movement and rearward movement of the work machine 1. The FR operation device 22 includes an FR lever for example. Alternatively, the FR operation device 22 may include a switch. The FR operation device 22 outputs an FR operation signal indicating an operation on the FR operation device 22.

The steering operation device 23 can be operated by an operator in order to steer the work machine 1. The steering operation device 23 includes, for example, a steering wheel. Alternatively, the steering operation device 23 may include a lever or a switch. The steering operation device 23 outputs a steering operation signal indicating an operation on the steering operation device 23.

The work machine 1 includes an engine rotation speed sensor 24 and an output rotation speed sensor 25. The engine rotation speed sensor 24 detects the actual rotation speed of the engine 11. The output rotation speed sensor 25 detects the output rotation speed of the transmission 14.

The work machine 1 includes a cooling temperature sensor 26 and a charge pressure sensor 27. The cooling temperature sensor 26 detects the temperature of the coolant for the engine 11. The charge pressure sensor 27 detects the actual charge pressure of the turbocharger 18. The work machine 1 includes an atmospheric pressure sensor 28 and an outdoor temperature sensor 29. The atmospheric pressure sensor 28 detects the atmospheric pressure. The outdoor temperature sensor 29 detects the outdoor temperature.

The work machine 1 includes a controller 30. The controller 30 controls the work machine 1. The controller 30 includes a storage device 31 and a processor 32. The storage device 31 includes a memory such as a RAM and a ROM for example. The storage device 31 may include a storage such as an HDD or an SSD. The storage device 31 stores a program and data for controlling the work machine 1. The processor 32 is, for example, a CPU. The processor 32 executes processing of controlling the work machine 1, in accordance with the program and data.

The controller 30 acquires the actual rotation speed of the engine 11 from the engine rotation speed sensor 24. The controller 30 acquires the output rotation speed of the transmission 14 from the output rotation speed sensor 25. The controller 30 acquires the actual charge pressure of the turbocharger 18 from the charge pressure sensor 27. The controller 30 acquires the temperature of the coolant for the engine 11 from the cooling temperature sensor 26. The controller 30 acquires the atmospheric pressure from the atmospheric pressure sensor 28. The controller 30 acquires the outdoor temperature from the outdoor temperature sensor 29.

The controller 30 receives the accelerator operation signal from the accelerator operation device 21. The controller 30 determines the target rotation speed of the engine 11 in accordance with the accelerator operation signal. The controller 30 controls the fuel injection amount from the fuel injection device 15 in accordance with the accelerator operation signal. The fuel injection amount from the fuel injection device 15 may be directly controlled in accordance with the operation on the accelerator operation device 21, without depending on the controller 30.

The controller 30 receives the FR operation signal from the FR operation device 22. The controller 30 switches the forward and the reverse of the transmission 14 according to the FR operation signal. The forward and reverse of the transmission 14 may be directly switched in accordance with the operation on the FR operation device 22, without depending on the controller 30.

The controller 30 switches the speed stage of the transmission 14 according to the vehicle speed or the actual rotation speed of the engine 11. The controller 30 calculates the vehicle speed from, for example, the output rotation speed of the transmission 14.

The controller 30 receives the steering operation signal from the steering operation device 23. The controller 30 controls the actuator 20 so as to change the steering angle of the traveling wheels 4 in accordance with the steering operation signal. The actuator 20 may be directly controlled in accordance with the operation on the steering operation device 23, without depending on the controller 30.

The work machine 1 includes the communication device 33. The communication device 33 is communicably connected to the controller 30. The communication device 33 communicates with a server 40 outside the work machine 1 by wireless communication. The server 40 remotely monitors the state of the work machine 1 by machine data indicating the state of the work machine 1.

The server 40 includes a storage device 41 and a processor 42. The storage device 41 includes a memory such as a RAM and a ROM for example. The storage device 41 may include a storage such as an HDD or an SSD. The storage device 41 stores a program and data for monitoring the state of the work machine 1. The processor 42 is, for example, a CPU. The processor 42 executes processing of monitoring the state of the work machine 1, in accordance with the program and data.

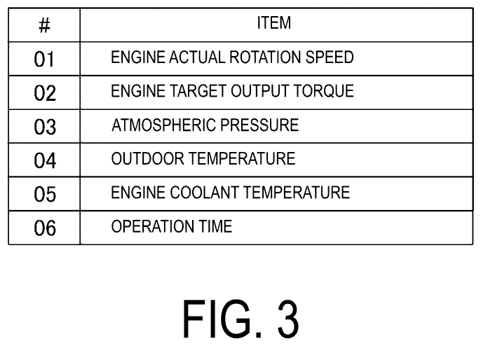

The controller 30 of the work machine 1 transmits the machine data to the server 40 via the communication device 33. FIG. 3 is a table illustrating a configuration of the machine data. As illustrated in FIG. 3, the machine data includes the actual rotation speed of the engine 11, the target output torque of the engine 11, the atmospheric pressure, the outdoor temperature, the temperature of the coolant for the engine 11, and an operation time. The target output torque of the engine 11 is calculated based on the rotation speed of the engine 11 and the fuel injection amount. The operation time is, for example, an integrated value of time during which the engine 11 is driven. The controller 30 counts and records the operation time.

The work machine 1 samples the above-described data at a predetermined sampling interval and stores the data as the machine data in the storage device 31. The work machine 1 transmits the accumulated machine data to the server 40 at a predetermined transmission timing. For example, upon entering a communicable area of a wireless LAN or the like, the work machine 1 transmits the accumulated machine data to the server 40. The server 40 generates determination data for evaluating the performance of the work machine 1 based on the received machine data. Hereinafter, processing executed by the server 40 for generating the determination data for evaluating performance will be described.

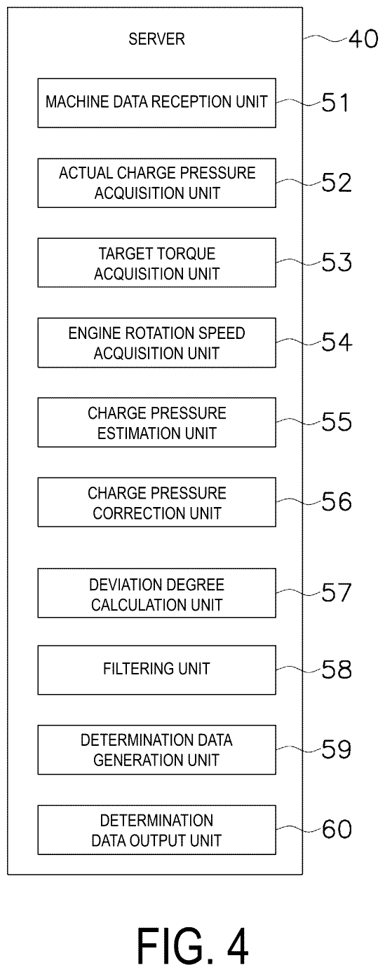

FIG. 4 is a block diagram illustrating a configuration of the server 40. As illustrated in FIG. 4, the server 40 includes a machine data reception unit 51, an actual charge pressure acquisition unit 52, a target torque acquisition unit 53, an engine rotation speed acquisition unit 54, a charge pressure estimation unit 55, a charge pressure correction unit 56, a deviation degree calculation unit 57, a filtering unit 58, a determination data generation unit 59, and a determination data output unit 60. The machine data reception unit 51, the actual charge pressure acquisition unit 52, the target torque acquisition unit 53, the engine rotation speed acquisition unit 54, the charge pressure estimation unit 55, the charge pressure correction unit 56, the deviation degree calculation unit 57, the filtering unit 58, the determination data generation unit 59, and the determination data output unit 60 are realized by the processor 42 of the server 40.

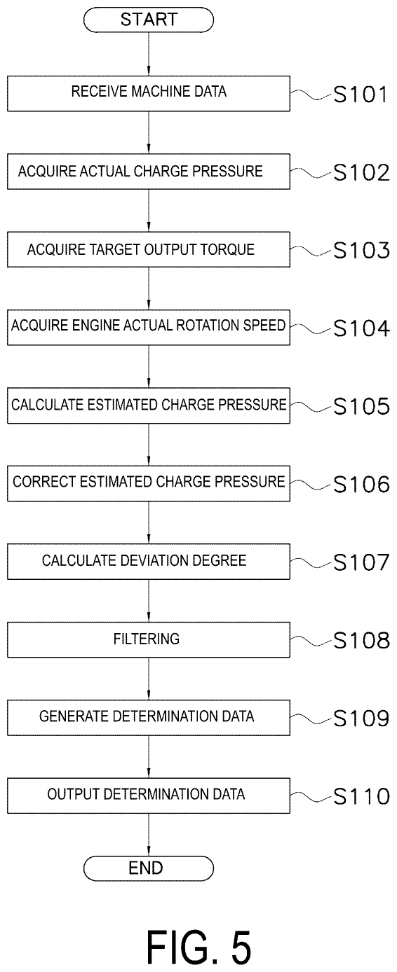

FIG. 5 is a flowchart illustrating the processing of generating the determination data for evaluating the performance. As illustrated in FIG. 5, in step S101, the machine data reception unit 51 receives machine data. The machine data reception unit 51 receives the above-described machine data from the controller 30 of the work machine 1.

In step S102, the actual charge pressure acquisition unit 52 acquires the actual charge pressure of the turbocharger 18. The actual charge pressure acquisition unit 52 acquires the actual charge pressure from the machine data received from the controller 30 of the work machine 1. In step S103, the target torque acquisition unit 53 acquires the target output torque of the engine 11. The target torque acquisition unit 53 acquires the target output torque of the engine 11 from the machine data received from the controller 30 of the work machine 1. In step S104, the engine rotation speed acquisition unit 54 acquires the actual rotation speed of the engine 11. The engine rotation speed acquisition unit 54 acquires the actual rotation speed of the engine 11 from the machine data received from the controller 30 of the work machine 1.

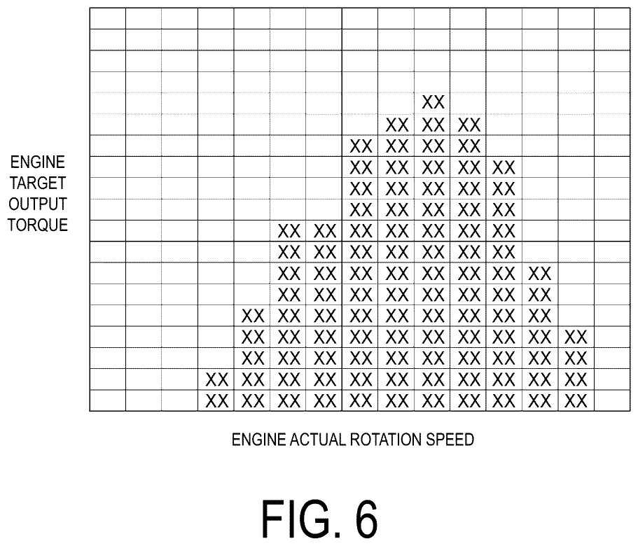

In step S105, the charge pressure estimation unit 55 calculates the estimated charge pressure. The charge pressure estimation unit 55 refers to the charge pressure estimation data and calculates the estimated charge pressure from the target output torque of the engine 11 and the actual rotation speed of the engine 11. FIG. 6 is a diagram illustrating an example of charge pressure estimation data. The charge pressure estimation data defines a relationship of the estimated charge pressure with respect to the target output torque of the engine 11 and the actual rotation speed of the engine 11. The charge pressure estimation data is, for example, a map that defines the relationship of the estimated charge pressure with respect to the target output torque of the engine 11 and the actual rotation speed of the engine 11. However, the charge pressure estimation data is not limited to the map, and may be indicated in other forms such as a mathematical expression or a table. The charge pressure estimation data is obtained in advance by simulation, bench test, or the like, and is stored in the storage device 41.

In step S106, the charge pressure correction unit 56 corrects the estimated charge pressure calculated in step S105. The charge pressure correction unit 56 corrects the estimated charge pressure using the following Formula (1):

$$Pcp\_corr = \{ Pcp ( Tr , S ) + Corr 1 ( Δ Tr 1 , Δ Tr 2 , ΔS 1 , Δ S 2 ) \} \times Corr 2 ( P\_atm , Te\_atm ) \qquad ( 1 )$$

where Pcp_corr is the corrected estimated charge pressure, Pcp (Tr, S) is the estimated charge pressure calculated from a target output torque Tr of the engine 11 and an actual rotation speed S of the engine 11 in step S105, and Corr1 (ΔTr1, ΔTr2, ΔS1, ΔS2) is a first correction term of the estimated charge pressure based on the target output torque of the engine 11 and the actual rotation speed of the engine 11.

The change amount of the target output torque Tr of the engine 11 is represented by ΔTr1 and ΔTr2. Thus, the charge pressure correction unit 56 corrects the estimated charge pressure based on the change amount of the target output torque Tr of the engine 11. The first torque change amount is represented by ΔTr1. The second torque change amount is represented by ΔTr2. The first torque change amount ΔTr1 is a change amount of the target output torque of the engine 11 during the first time period. The second torque change amount ΔTr2 is a change amount of the target output torque of the engine 11 during the second time period. The second time period is longer than the first time period. For example, the first time period is 1 second, and the second time period is 2 seconds. However, the first time period and the second time period are not limited to these time periods, and may be changed.

The change amount of the actual rotation speed of the engine 11 is represented by ΔS1 and ΔS2. Thus, the charge pressure correction unit 56 corrects the estimated charge pressure based on the change amount of the actual rotation speed of the engine 11. The first rotation speed change amount is represented by ΔS1. The second rotation speed change amount is represented by ΔS2. The first rotation speed change amount ΔS1 is a change amount of the actual rotation speed of the engine 11 during the first time period. The second rotation speed change amount ΔS2 is a change amount of the actual rotation speed of the engine 11 during the second time period.

Specifically, the first correction term Corr1 (ΔTr1, ΔTr2, ΔS1, ΔS2) is expressed by the following Formula (2). In Formula (2), a1 to a6 represent predetermined coefficients, obtained in advance by simulation, bench test, or the like, and stored in the storage device 41,

$$Corr 1 ( Δ Tr 1 , Δ Tr 2 , Δ S 1 , Δ S 2 ) = a 1 \times Δ Tr 1 + a 2 \times Δ Tr 2 + a 3 \times Δ S 1 + a 4 \times Δ S 2 + a 5 \times \vert Δ Tr 1 \vert + a 6 \times \vert Δ S 1 \vert \qquad ( 2 )$$

Corr2 (P_atm, Te_atm) represents a second correction term of the estimated charge pressure based on the atmospheric pressure and the outdoor temperature, P_atm represents the atmospheric pressure, and Te_atm represents the outdoor temperature. Thus, the charge pressure correction unit 56 corrects the estimated charge pressure based on the atmospheric pressure and the outdoor temperature. The second correction term Corr2 (P_atm, Te_atm) is expressed by the following Formula (3):

$$Corr 2 ( P\_atm , Te\_atm ) = ( 1 + ( b 1 \times \frac{{Pcp}^{′} - P\_atm}{Pcp\_rated} \times ( \frac{P\_atm}{P\_standard} - 1 ) ) ) \times ( 1 + ( b 2 \times \frac{{Pcp}^{′} - P\_atm}{Pcp\_rated} \times ( \frac{Te\_atm}{Te\_standard} - 1 ) ) ) \qquad ( 3 )$$

where Pcp_rated represents the charge pressure at the rated point obtained in advance by simulation, bench test, or the like, and stored in the storage device 41, P_standard represents the standard atmospheric pressure, Te_standard represents the standard temperature, P_standard and Te_standard are stored in the storage device 41, b1 and b2 represent predetermined coefficients obtained in advance by simulation, bench test, or the like, and stored in the storage device 41, and Pcp′ represents the estimated charge pressure corrected by the first correction term. Thus, Pcp′ is expressed by the following Formula (4).

$${Pcp}^{′} = Pcp ( Tr , S ) + Corr 1 ( Δ Tr 1 , Δ T r 2 , Δ S 1 , Δ S 2 ) \qquad ( 4 )$$

In step S107, the deviation degree calculation unit 57 calculates the deviation degree between the actual charge pressure and the corrected estimated charge pressure. The deviation degree calculation unit 57 calculates the deviation degree using the following Formula (5): where Pcr represents the actual charge pressure. The deviation degree Dev_charge is a ratio of a difference between the actual charge pressure and the corrected estimated charge pressure to the corrected estimated charge pressure. The deviation degree Dev_charge is expressed in percentage.

$$Dev\_charge = ( \frac{Pcr}{Pcp} - 1 ) \times 100 \qquad ( 5 )$$

In step S108, the filtering unit 58 performs filtering for the deviation degree calculated in step S107. The filtering unit 58 selects the deviation degree acquired when a predetermined condition is satisfied. The predetermined condition includes the following first to eleventh conditions.

The first condition is satisfied when the actual rotation speed of the engine 11 is equal to or higher than a predetermined lower limit value. The second condition is satisfied when the actual rotation speed of the engine 11 before the first time period is equal to or higher than a predetermined lower limit value. The third condition is satisfied when the actual rotation speed of the engine 11 before the second time period is equal to or higher than a predetermined lower limit value. The fourth condition is that the target output torque of the engine is equal to or higher than a predetermined lower limit value. The fifth condition is satisfied when the target output torque of the engine before the first time period is equal to or greater than a predetermined lower limit value. The sixth condition is satisfied when the target output torque of the engine before the second time period is equal to or greater than a predetermined lower limit value. The first to the sixth conditions are set to exclude data acquired when the engine is in an idling state, for example.

The seventh condition is that the first rotation speed change amount is within a predetermined range. The eighth condition is that the second rotation speed change amount is within a predetermined range. The ninth condition is that the first torque change amount is within a predetermined range. The tenth condition is that the second torque change amount is within a predetermined range. The seventh to the tenth conditions are set to exclude data having a large change amount exceeding a range in which accurate correction is possible. The eleventh condition is that the temperature of the coolant for the engine is within a predetermined range. The eleventh condition is set to exclude data in a state where the engine is not sufficiently warmed up.

The filtering unit 58 determines whether the first to eleventh conditions are satisfied based on the machine data described above. The filtering unit 58 selects the deviation degree that satisfies all of the first to the eleventh conditions. The filtering unit 58 excludes the deviation degree that does not satisfy at least one of the first to the eleventh conditions.

In step S109, the determination data generation unit 59 generates the determination data. The determination data generation unit 59 records the deviation degrees selected in step S108 in time series, thereby generating the determination data for evaluating the performance. For example, the determination data generation unit 59 calculates an average value of the deviation degree for each predetermined operation time, and generates time-series data of the average value of the deviation degree as the determination data.

In step S110, the determination data output unit 60 outputs the determination data. For example, the determination data output unit 60 transmits the determination data to a computer of a user of the work machine 1. Alternatively, the determination data output unit 60 may cause a display to display the determination data, using an application for managing the work machine 1.

The server 40 may evaluate the performance of the turbocharger 18 based on the determination data. The determination data output unit 60 may transmit the evaluation result of the performance of the turbocharger 18 determined based on the determination data to the computer of the user of the work machine 1. For example, the server 40 may determine that the performance of the turbocharger 18 has been suddenly compromised, in response to a sharp decrease or sharp increase in the deviation degree in the determination data. The server 40 may determine that the performance of the turbocharger 18 has been compromised due to aging deterioration, when the deviation degree in the determination data is equal to or less than a predetermined threshold value.

In the system for evaluating the performance of the work machine 1 according to the present embodiment described above, the estimated charge pressure is corrected based on the change amount of the target output torque of the engine 11 and the change amount of the actual rotation speed of the engine 11. Therefore, the estimated charge pressure is corrected in consideration of a change in the load on the work machine 1 or change in the operation state of the engine 11 according to the operation on the accelerator operation device 21. Accordingly, the deviation degree can be calculated with high accuracy in the work machine 1.

Although one embodiment of the present invention has been described above, the present invention is not limited to the above-described embodiment, and various modifications can be made without departing from the gist of the invention.

The work machine 1 is not limited to a dump truck and may be another machine such as a bulldozer, an excavator, a wheel loader or a grader. The dump truck is not limited to a rigid dump truck, and may be an articulated dump truck. The traveling device 3 is not limited to the traveling wheels 4, and may include a crawler belt. The work machine 1 may include a plurality of controllers. The processing for controlling the work machine 1 by the controller 30 described above may be distributed to and executed by the plurality of controllers.

The work machine 1 may be remotely operable. In this case, the accelerator operation device 21, the FR operation device 22, and the steering operation device 23 may be arranged outside the work machine 1. The work machine 1 may be capable of autonomous traveling. In this case, the accelerator operation signal, the FR operation signal, and the steering operation signal may be automatically generated by the controller 30.

The processing for generating the determination data described above may be executed by the controller 30 of the work machine 1. Alternatively, the processing for generating the determination data described above may distributed to and executed by the controller 30 of the work machine 1 and the server 40. The evaluation of the performance of the turbocharger 18 may be performed by the controller 30 of the work machine 1. The controller 30 may display the evaluation of the performance of the turbocharger 18 on a display of the work machine 1.

The method for generating the determination data is not limited to that of the above embodiment and may be modified. For example, the correction parameter for correcting the estimated charge pressure is not limited to the target output torque of the engine 11. The correction parameter may be a fuel injection amount, an instantaneous fuel consumption amount, an operation amount on the accelerator operation device 21, or a throttle opening degree. The first torque change amount and the second torque change amount may be change amounts of these correction parameters.

The estimated charge pressure may be corrected only based on the target output torque of the engine 11, and not based on the actual rotation speed of the engine 11. The estimated charge pressure may be corrected only based on the actual rotation speed of the engine 11, and not based on the target output torque of the engine 11. The correction of the estimated charge pressure based on the atmospheric pressure may be omitted. The correction of the estimated charge pressure based on the outdoor temperature may be omitted.

The deviation degree is not limited to that of the above embodiment and may be modified. For example, the deviation degree may be a ratio between the actual charge pressure and the corrected estimated charge pressure. Alternatively, the deviation degree may be a deviation between the actual charge pressure and the corrected estimated charge pressure. The predetermined conditions for filtering the deviation degree are not limited to those of the above embodiment and may be modified. Some of the first to the eleventh conditions described above may be omitted or changed. For example, the predetermined condition may include a condition for filtering based on a fuel injection amount, an instantaneous fuel consumption amount, an operation amount on the accelerator operation device 21, or a throttle opening degree. The machine data is not limited to that of the above embodiment and may be modified.

According to the present disclosure, it is possible to accurately calculate a deviation degree of a charge pressure in a work machine.

1. A system for evaluating performance of a work machine including an engine and a turbocharger connected to the engine, the system comprising:
an actual charge pressure acquisition unit configured to acquire an actual charge pressure of the turbocharger;
a target torque acquisition unit configured to acquire a target output torque of the engine;
an engine rotation speed acquisition unit configured to acquire an actual rotation speed of the engine;
a charge pressure estimation unit configured to calculate an estimated charge pressure of the turbocharger based on the target output torque of the engine and the actual rotation speed of the engine;
a charge pressure correction unit configured to
acquire a change amount of a predetermined correction parameter in order to change the target output torque of the engine as a first torque change amount, and
correct the estimated charge pressure based on the first torque change amount; and
a deviation degree calculation unit configured to calculate a deviation degree between the actual charge pressure and the corrected estimated charge pressure.

2. The system according to claim 1, wherein
the predetermined correction parameter is the target output torque.

3. The system according to claim 2, wherein
the first torque change amount is a change amount of the target output torque during a first time period.

4. The system according to claim 3, wherein
the charge pressure correction unit is configured to
acquires acquire a second torque change amount indicating a change amount of the target output torque during a second time period longer than the first time period, and
correct the estimated charge pressure based on the first torque change amount and the second torque change amount.

5. The system according to claim 1, wherein
the charge pressure correction unit is configured to
acquire a first rotation speed change amount indicating a change amount of the actual rotation speed of the engine, and
correct the estimated charge pressure based on the first rotation speed change amount.

6. The system according to claim 5, wherein
the first rotation speed change amount is a change amount of the actual rotation speed of the engine during a first time period.

7. The system according to claim 6, wherein
the charge pressure correction unit is configured to
acquire a second rotation speed change amount indicating a change amount of the actual rotation speed of the engine during a second time period longer than the first time period, and
correct the estimated charge pressure based on the first rotation speed change amount and the second rotation speed change amount.

8. The system according to claim 1, wherein
the charge pressure correction unit is configured to
acquire an atmospheric pressure, and
correct the estimated charge pressure based on the atmospheric pressure.

9. The system according to claim 1, wherein
the charge pressure correction unit is configured to
acquire an outdoor temperature, and
correct the estimated charge pressure based on the outdoor temperature.

10. The system according to claim 1 further comprising:
a filtering unit configured to select the deviation degree acquired when a predetermined condition is satisfied,
the predetermined condition including the target output torque of the engine being within a predetermined range.

11. The system according to claim 1 further comprising:
a determination data generation unit configured to generate data in order to evaluate the performance by recording the deviation degree in time series.

12. A system for evaluating performance of a work machine including an engine and a turbocharger connected to the engine, the system comprising:
an actual charge pressure acquisition unit configured to acquire an actual charge pressure of the turbocharger;
a target torque acquisition unit configured to acquire a target output torque of the engine;
an engine rotation speed acquisition unit configured to acquire an actual rotation speed of the engine;
a charge pressure estimation unit configured to calculate an estimated charge pressure of the turbocharger based on the target output torque of the engine and the actual rotation speed of the engine;
a charge pressure correction unit configured to
acquire a first rotation speed change amount indicating a change amount of the actual rotation speed of the engine, and
correct the estimated charge pressure based on the first rotation speed change amount; and
a deviation degree calculation unit configured to calculate a deviation degree between the actual charge pressure and the corrected estimated charge pressure.

13. The system according to claim 12, wherein
the first rotation speed change amount is a change amount of the actual rotation speed of the engine during a first time period.

14. The system according to claim 13, wherein
the charge pressure correction unit is configured to
acquire a second rotation speed change amount indicating a change amount of the actual rotation speed of the engine during a second time period longer than the first time period, and
correct the estimated charge pressure based on the first rotation speed change amount and the second rotation speed change amount.

15. The system according to claim 12 further comprising:
a filtering unit configured to select the deviation degree acquired when a predetermined condition is satisfied,
the predetermined condition including the first rotation speed change amount being within a predetermined range.

16. The system according to claim 12, wherein
the charge pressure correction unit is configured to
acquire an atmospheric pressure, and
correct the estimated charge pressure based on the atmospheric pressure.

17. The system according to claim 12, wherein
the charge pressure correction unit is configured to
acquire an outdoor temperature, and
correct the estimated charge pressure based on the outdoor temperature.

18. The system according to claim 12 further comprising:
a determination data generation unit configured to generate data in order to evaluate the performance by recording the deviation degree in time series.

19. A method for evaluating performance of a work machine including an engine and a turbocharger connected to the engine, the method comprising:
acquiring an actual charge pressure of the turbocharger;
acquiring a target output torque of the engine;
acquiring an actual rotation speed of the engine;
calculating an estimated charge pressure of the turbocharger based on the target output torque of the engine and the actual rotation speed of the engine;
acquiring a change amount of a predetermined correction parameter in order to change the target output torque of the engine as a first torque change amount, and correcting the estimated charge pressure based on the first torque change amount; and
calculating a deviation degree between the actual charge pressure and the corrected estimated charge pressure.

20. A method for evaluating performance of a work machine including an engine and a turbocharger connected to the engine, the method comprising:
acquiring an actual charge pressure of the turbocharger;
acquiring a target output torque of the engine;
acquiring an actual rotation speed of the engine;
calculating an estimated charge pressure of the turbocharger based on the target output torque of the engine and the actual rotation speed of the engine;
acquiring a first rotation speed change amount indicating a change amount of the actual rotation speed of the engine, and correcting the estimated charge pressure based on the first rotation speed change amount; and
calculating a deviation degree between the actual charge pressure and the corrected estimated charge pressure.
